(19) United States
(12) Patent Application Publication
(10) Pub. No.: US 2016/0071493 A1
(43) Pub. Date: Mar. 10, 2016

(54) DISPLAY DEVICE AND DISPLAY METHOD THEREOF FOR COMPENSATING PIXEL VOLTAGE LOSS

(71) Applicant: Innolux Corporation, Miao-Li County (TW)

(72) Inventor: Masahiro YOSHIGA, Miao-Li County (TW)

(73) Assignee: INNOLUX CORPORATION, Miao-Li County (TW)

(21) Appl. No.: 14/482,564

(22) Filed: Sep. 10, 2014

(51) Int. Cl. G09G 5/18

(52) U.S. Cl. CPC G09G 5/18

(57) ABSTRACT

A display device comprises data lines, pixel units and gate lines. The data lines are for providing pixel voltages. The pixel units are for displaying images in response to the pixel voltages. The pixel units comprise pixel capacitors and pixel switches for transmitting the pixel voltages from the data lines to the pixel capacitors. The gate lines are for controlling the pixel switches. During a suspend period, the pixel switches are turned off and a compensation voltage is applied to the gate lines or a light shield disposed along the gate lines.

### TECHNICAL FIELD

The disclosure relates in general to a display device and a display method thereof, and more particularly to a display device and a display method thereof for compensating pixel voltage loss.

### BACKGROUND

Recently, active matrix display devices are commonly used in computer systems, televisions and other portable electronic devices. In general, the active matrix display devices include pixels for displaying images according to pixel voltages stored therein. However, the pixel voltages stored in the pixels is subject to loss with time due to leaking current. The leaking current causes reduction in the pixel voltage and renders flicker.

Therefore, there is a need to provide a display device capable of compensating the pixel voltage loss.

### SUMMARY

The disclosure is directed to a display device and a display method thereof for compensating pixel voltage loss.

According to one embodiment, a display device is provided. The display device comprises data lines, pixel units and gate lines. The data lines are for providing pixel voltages. The pixel units are for displaying images in response to the pixel voltages. The pixel units comprise pixel capacitors and pixel switches for transmitting the pixel voltages from the data lines to the pixel capacitors. The gate lines are for controlling the pixel switches. During a suspend period, the pixel switches are turned off and a compensation voltage is applied to the gate lines.

According to an alternative embodiment of the present invention, a display device is provided. The display device comprises data lines, pixel units, gate lines and light shield lines disposed along the gate lines. The data lines are for providing pixel voltages. The pixel units are for displaying images in response to the pixel voltages. The pixel units comprise pixel capacitors and pixel switches for transmitting the pixel voltages from the data lines to the pixel capacitors. The gate lines are for controlling the pixel switches. During a suspend period, the pixel switches are turned off and a compensation voltage is applied to the light shield lines, wherein the compensation voltage has a predetermined value not changing with the level of the pixel voltages.

### BRIEF DESCRIPTION OF THE DRAWINGS

FIG. 1 shows an example of a display device according to an embodiment of the present invention.

FIG. 2 shows an example of the pixel unit according to an embodiment of the present invention.

FIG. 3 shows a circuit diagram of a pixel unit according to another embodiment of the present invention.

FIG. 4 is a timing chart illustrating a first example of compensation operation of the display device 100 according to an embodiment of the present invention.

FIG. 5 is a timing chart illustrating a second example of compensation operation of the display device according to an embodiment of the present invention.

FIG. 6 is a timing chart illustrating a third example of compensation operation of the display device according to an embodiment of the present invention.

FIG. 7 shows a circuit diagram of a pixel unit according to another embodiment of the present invention.

FIG. 8 shows simulation results of the relationship between the pixel voltage change of the display device and that of a conventional display device using VCOM compensation.

FIG. 9 shows simulation results of the relationship between the intensity change of the display device and that of the conventional display device using VCOM compensation.

FIG. 10 shows simulation results of the relationship between the intensity change with different gray levels for the display device and that for the conventional display device using VCOM compensation.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

Below, exemplary embodiments will be described in detail with reference to accompanying drawings so as to be easily realized by a person having ordinary knowledge in the art. The inventive concept may be embodied in various forms without being limited to the exemplary embodiments set forth herein. Descriptions of well-known parts are omitted for clarity, and like reference numerals refer to like elements throughout.

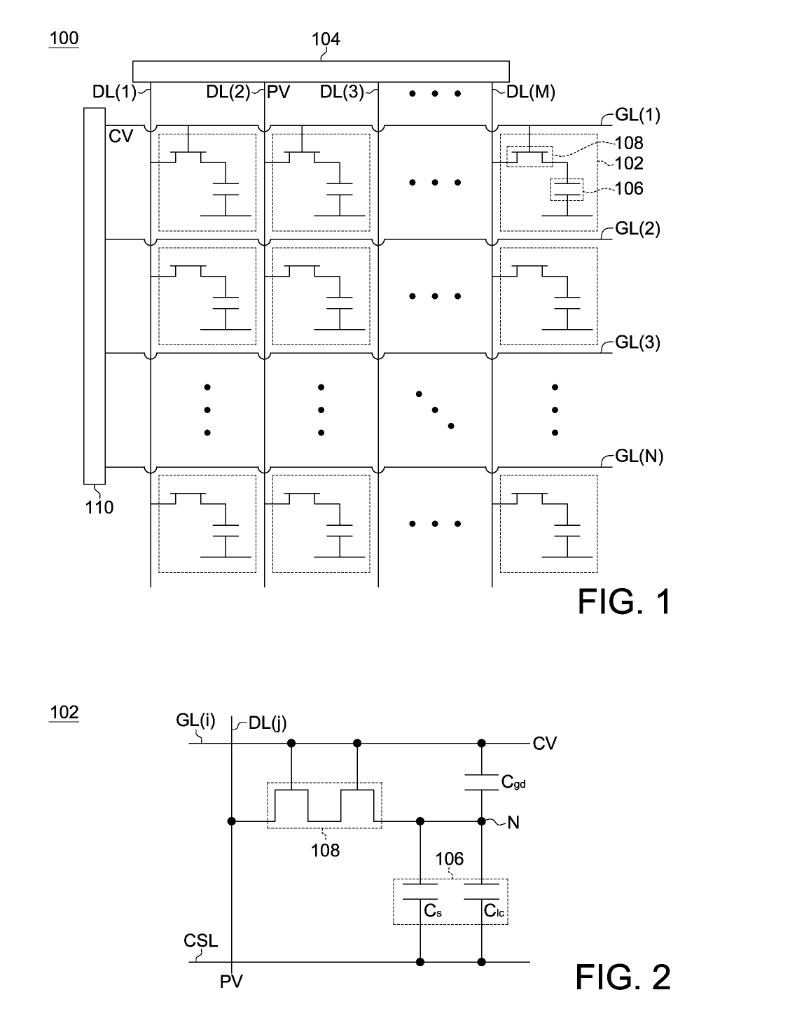

FIG. 1 shows an example of a display device 100 according to an embodiment of the present invention. The display device 100 comprises data lines DL(1)-DL(M), pixel units 102 and gate lines GL(1)-GL(N), where M and N are positive integers. The data lines DL(1)-DL(M) are for providing pixel voltages PV. For example, a source driver 104 is connected to the data lines DL(1)-DL(M) for applying the pixel voltages PV to the pixel units 102 through the data lines DL(1)-DL(M). The pixel units 102 are for displaying images in response to the pixel voltages PV. As shown in FIG. 1, the pixel units 102 comprise pixel capacitors 106 and pixel switches 108 for transmitting the pixel voltages PV from the data lines DL(1)-DL(M) to the pixel capacitors 106. The gate lines GL(1)-GL(N) are for controlling the pixel switches 108. For example, a gate driver 110 is connected to the gate lines GL(1)-GL(N) for applying gate voltages to the pixel units 102 through the gate lines GL(1)-GL(N) to turn on or off the pixel switches 108 of the pixel units 102.

When the pixel switches 108 are turned off and the display device 100 enters a suspend period, the pixel voltages PV stored in the pixel capacitors 106 would decrease with time due to the leaking currents. In order to compensate the loss of pixel voltage, during the suspend period that the pixel switches 108 are turned off, a compensation voltage CV is applied to the gate lines GL(1)-GL(N) or a light shield disposed along the gate lines GL(1)-GL(N) to compensate the loss of the pixel voltages PV.

FIG. 2 shows an example of the pixel unit 102 according to an embodiment of the present invention. In the example of FIG. 2, the pixel capacitor 106 comprises a storage capacitor Cₛ and a liquid crystal capacitor C_{lc}. The storage capacitor Cₛ and the liquid crystal capacitor C_{lc} are connected in parallel and coupled between a node N and a common source line CSL. When the gate line GL(i) is at high level, the pixel switch 108, e.g., thin film transistors (TFTs), is turned on to transfer the pixel voltage PV from the data line DL(j) to the pixel capacitor 106. When the gate line GL(i) is at low level, the pixel switch 108 is turned off and the pixel capacitor 106 maintains the received pixel voltage PV. In the embodiment, the compensation voltage CV is at a low level not enough to turn on the pixel switch 108. When the compensation voltage CV is applied through the gate line GL(i), the pixel switch 108 is still turned off and the level of the pixel voltage PV stored in the pixel capacitor 106 is shifted due to the coupling capacitor C_{gd} between the node N and the gate line GL(i). At this time, the voltage level of node N can be expressed as follows:

$$NV = \frac{{C}_{gd}}{{C}_{s} + {C}_{lc} + {C}_{gd}} \times CV \qquad ( 1 )$$

As can be seen from equation (1), by adjusting the magnitude of the compensation voltage CV appropriately, the voltage level of node N can be shifted and the loss of the pixel voltage PV can be compensated.

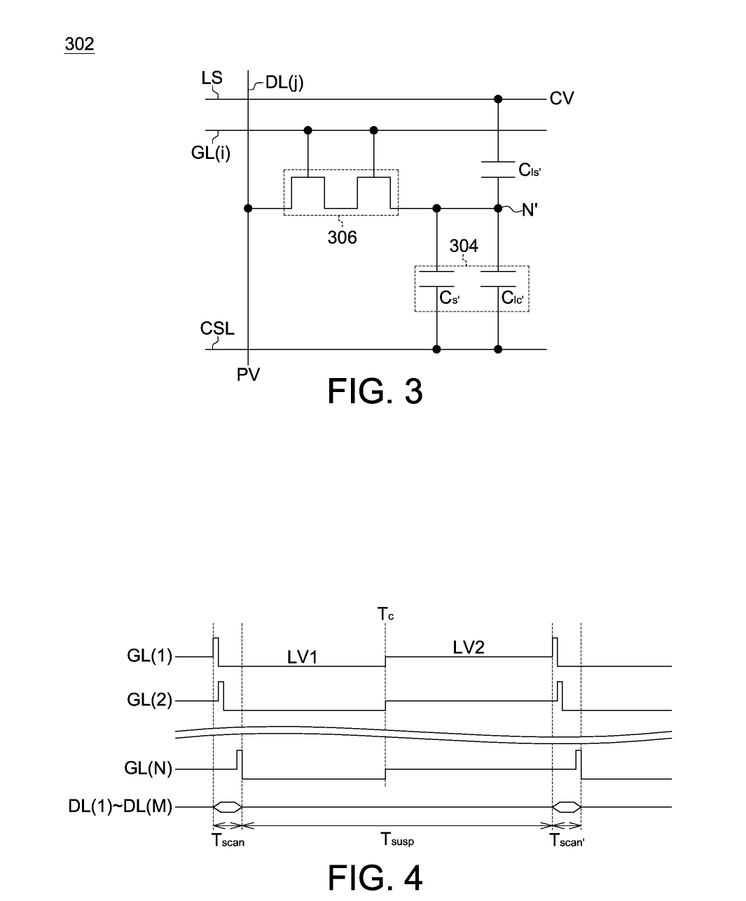

FIG. 3 shows a circuit diagram of a pixel unit 302 according to another embodiment of the present invention. The pixel unit 302 can be used in the display device 100 and replace the pixel unit 102. The main difference between the pixel unit 302 and the previous embodiment is that the compensation voltage CV is applied through a light shield LS split along the gate line GL(i). The pixel unit 302 comprises a pixel capacitor 304 and pixel switches 306 for transmitting the pixel voltages PV from the data lines DL(j) to the pixel capacitor 304. The pixel capacitor 304 includes a liquid crystal capacitor C_{lc} and a storage capacitor C_{s′}. When the compensation voltage CV is applied through the light shield LS, the pixel switch 306 is still turned off and the level of the pixel voltage PV stored in the pixel capacitor 304 is shifted due to the coupling capacitor C_{ls′} between the node N′ and the light shield LS. At this time, the voltage level of node N′ can be expressed as follows:

$${NV}^{′} = \frac{{C}_{{ls}^{′}}}{{C}_{{s}^{′}} + {C}_{{lc}^{′}} + {C}_{{ls}^{′}}} \times CV \qquad ( 2 )$$

As can be seen from equation (2), by adjusting the magnitude of the compensation voltage CV appropriately, the voltage level of node N′ can be shifted and the loss of the pixel voltage PV can be compensated.

FIG. 4 is a timing chart illustrating a first example of compensation operation of the display device 100 according to an embodiment of the present invention. As shown in FIG. 4, during a scan period T_{scan}, a plurality of scanning pulses are sequentially applied to the gate lines GL(1)-GL(N) to turn on the pixel switches 108. At the end of the scan period T_{scan}, the charging for the pixel units 102 is finished and the pixel voltages PV supplied by the data lines DL(1)-DL(N) are stored in the pixel units 102. The suspend period Tₛᵤₛₚ is subsequent to the scan period T_{scan}. During the suspend period Tₛᵤₛₚ, the gate lines GL(1)-GL(N) are at low levels and the pixel switches 108 are at OFF state. The low level can be a first level LV1 or a second level LV2 higher than the first level LV1. The compensation voltage CV can be defined as, but not limited to, the difference between the first level LV1 and the second level LV2. In the example of FIG. 4, the compensation voltage CV is applied to the gate lines GL(1)-GL(N) at the same timing T_{c} so that voltage levels on the gate lines GL(1)-GL(N) change from the first level LV1 to the second level LV2. After that, each of the gate lines GL(1)-GL(N) is maintained at the second level LV2 until the corresponding pixel switch 108 is switched to ON state in the next scan period T_{scan′}.

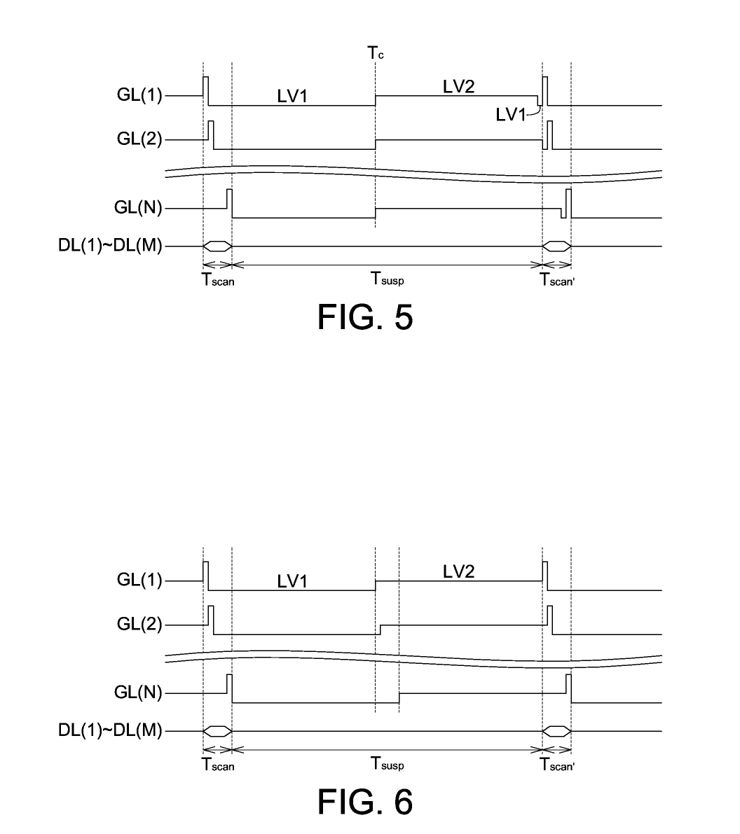

FIG. 5 is a timing chart illustrating a second example of compensation operation of the display device 100 according to an embodiment of the present invention. The main difference between the timing chart shown in FIG. 5 and that shown in FIG. 4 is that the voltage level on each gate line GL(1)-GL(N) turns back from the second level LV2 to the first level LV1 just before the corresponding pixel switch 108 is switched to ON state. As shown in FIG. 5, during the suspend period Tₛᵤₛₚ, the gate lines GL(1)-GL(N) are at low levels and the pixel switches 108 are at OFF state. The compensation voltage CV is applied to the gate lines GL(1)-GL(N) at the same timing T_{c} so that voltage levels on the gate lines GL(1)-GL(N) change from the first level LV1 to the second level LV2. For each gate line GL(1)-GL(N), the voltage level thereon may turn back from the second level LV2 to the first level LV1 before the corresponding pixel switch 108 is switched to ON state in the next scan period T_{scan′}. Accordingly, the voltage levels on the gate lines GL(1)-GL(N) may turn back from the second level LV2 to the first level LV1 at different timing. As shown in FIG. 5, the timing that the voltage levels on the gate lines GL(1)-GL(N) turn back from the second level LV2 to the first level LV1 is depend on the timing that the pixel switches 108 are switched to ON state in the next scan period T_{scan′}.

FIG. 6 is a timing chart illustrating a third example of compensation operation of the display device 100 according to an embodiment of the present invention. The main difference between the timing chart shown in FIG. 6 and that shown in FIG. 4 is that the compensation voltage CV is applied to the gate lines GL(1)-GL(N) at the different timing. The compensation voltage CV can be applied to the gate lines GL(1)-GL(N) sequentially. As shown in FIG. 6, during the suspend period Tₛᵤₛₚ, voltage levels on the gate lines GL(1)-GL(N) change from the first level LV1 to the second level LV2 sequentially. After that, each of the gate lines GL(1)-GL(N) is maintained at the second level LV2 until the corresponding pixel switch 108 is switched to ON state.

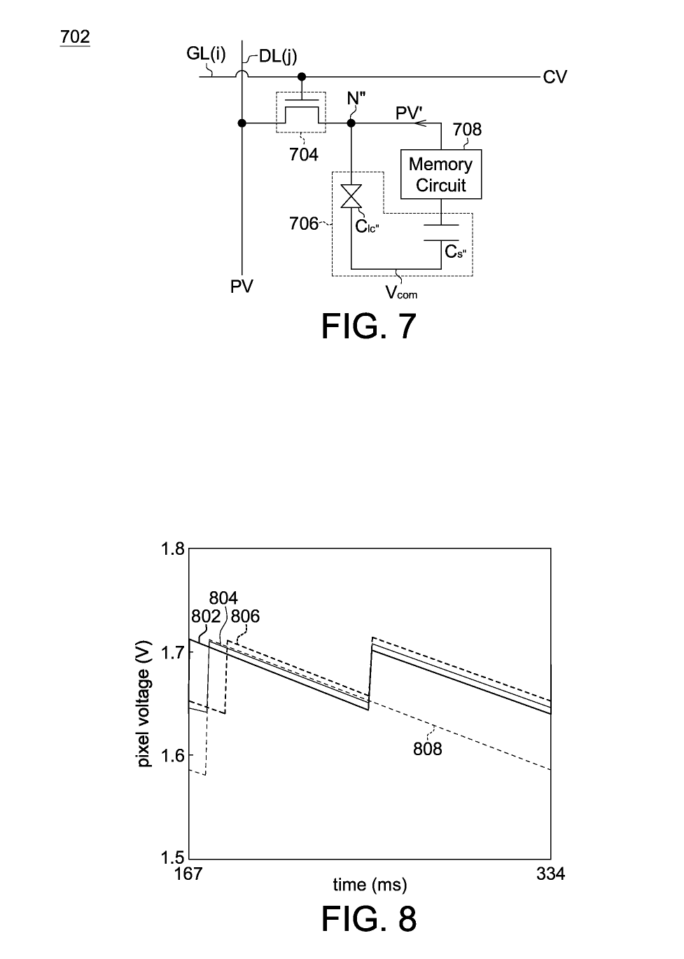

FIG. 7 shows a circuit diagram of a pixel unit 702 according to another embodiment of the present invention. The pixel unit 702 can be used in the display device 100 and replace the pixel unit 102. The main difference between the pixel unit 702 and the previous embodiment is that the pixel unit 702 has a memory-in-pixel (MIP) structure. As shown in FIG. 7, the pixel unit 702 includes a pixel switch 704 having a gate terminal electrically coupled to a corresponding gate line GL(i), a source electrically coupled to a corresponding data line DL(j), and a drain terminal electrically coupled to a node N″. A pixel capacitor 706 including a liquid crystal capacitor C_{lc} and a storage capacitor C_{s″} is coupled between a node N″ and a common voltage Vcom. The pixel unit 702 further comprises a memory circuit 708. The memory circuit 708 is electrically coupled between one end of the storage capacitor C_{st′} and the node N′.

When the pixel switch 704 is turned on by the corresponding gate line GL(i), pixel voltage PV is applied through the corresponding data line DL(j) to the liquid crystal capacitor C_{lc″} and the memory circuit 708 so that the pixel voltage PV is written in the pixel unit 702 for display. When the pixel switch 704 is turned off, the memory circuit 708 supplies a corresponding stored pixel voltage PV′ to the liquid crystal capacitor C_{lc″} in response to the voltage stored in the storage capacitor C_{s″}. In this case, the displayed image can be refreshed according to the stored pixel voltage PV. Similar to the previous embodiments, a compensation voltage CV can be applied through the gate line GL(i) (or a light shield disposed along with the gate line GL(i), if existent) to shift the pixel voltage PV stored in the pixel capacitor 706, hence reducing the number of the above-mentioned refresh operation and getting much lower power consumption.

FIG. 8 shows simulation results of the relationship between the pixel voltage change of the display device 100 and that of a conventional display device. In FIG. 8, curve 802 is the pixel voltage of the pixel unit coupled to the first gate line GL(1), curve 804 is the pixel voltage of the pixel unit coupled to the central gate line GL(K), where K is the medium between 1 and M, curve 806 is the pixel voltage of the pixel unit coupled to the last gate line GL(M), and curve 808 is the pixel voltage of a pixel unit of the conventional display device using VCOM compensation. As can be seen from FIG. 8, the pixel voltage compensation effect is a bit different from each gate line GL(1), GL(K), GL(M), but all pixel voltages are well compensated and become smaller change than the conventional display device.

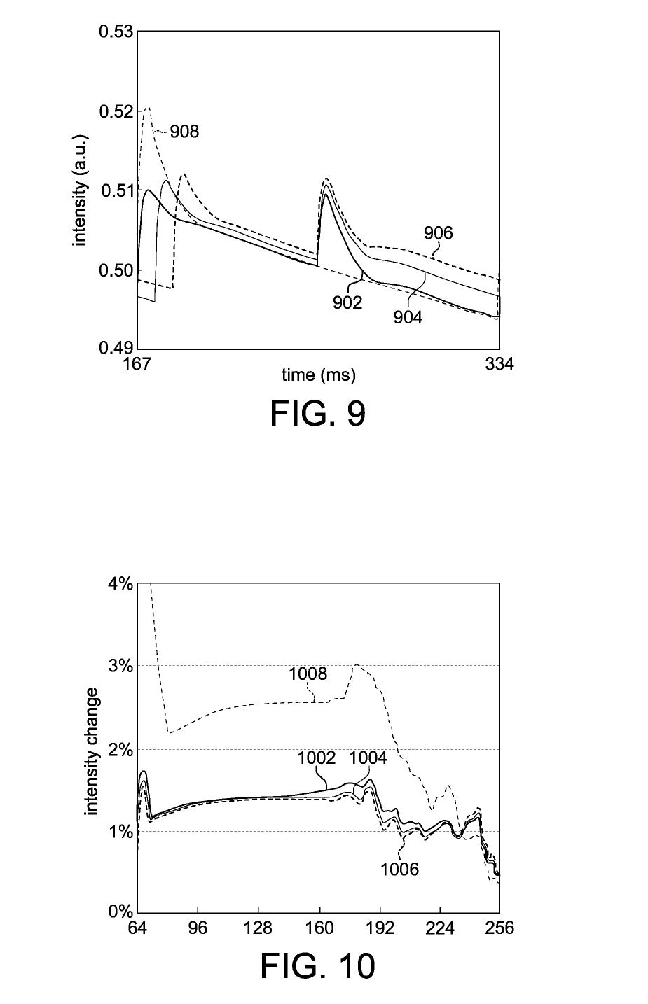

FIG. 9 shows simulation results of the relationship between the intensity change of the display device 100 and that of the conventional display device. In FIG. 9, curve 902 is the intensity of the pixel unit coupled to the first gate line GL(1), curve 904 is the intensity of the pixel unit coupled to the central gate line GL(K), curve 906 is the intensity of the pixel unit coupled to the last gate line GL(M), and curve 908 is the intensity of a pixel unit of the conventional display device. As can be seen from FIG. 9, all intensity change becomes smaller than the conventional display device.

FIG. 10 shows simulation results of the relationship between the intensity change with different gray levels for the display device 100 and that for the conventional display device. In FIG. 10, curve 1002 is the intensity change of the pixel unit coupled to the first gate line GL(1), curve 1004 is the intensity change of the pixel unit coupled to the central gate line GL(K), curve 1006 is the intensity change of the pixel unit coupled to the last gate line GL(M), and curve 1008 is the intensity change of a pixel unit of the conventional display device. As can be seen from FIG. 10, the same compensation voltage CV can be applied for all gray level, and the intensity change is improved. In other words, in the embodiments, there is no need to change the compensation voltage CV for any gray level. The compensation voltage CV can have a predetermined value not changing with the level of the pixel voltages PV.

According to an alternative embodiment of the present invention, a display method of a display device including data lines, pixel units and gate lines is provided. The display method comprises the following steps: the data lines provide pixel voltages; the pixel units display images in response to the pixel voltages, wherein the pixel units comprises pixel capacitors and pixel switches for transmitting the pixel voltages from the data lines to the pixel capacitors; the gate lines control the pixel switches; and during a suspend period, the pixel switches are turned off and a compensation voltage is applied to the gate lines or a light shield disposed along the gate lines to compensate a loss of the pixel voltages.

Based on the above, the display device and display method thereof according to various embodiments of the present invention compensate the pixel voltage loss by way of applying a compensation voltage to the gate lines or a light shield disposed along the gate lines. Since the gate lines are already split for each row of pixel units, horizontal crosstalk issue can be avoid. Moreover, it is found that the same compensation voltage can be applied for all gray level, and the intensity change is improved. Accordingly, there is no need to change the compensation voltage for any gray level and the compensation voltage can be simply predetermined by manufacturer.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. A display device, comprising:
data lines for providing pixel voltages;
pixel units for displaying images in response to the pixel voltages, the pixel units comprising:
pixel capacitors; and
pixel switches for transmitting the pixel voltages from the data lines to the pixel capacitors; and
gate lines for controlling the pixel switches;
wherein during a suspend period, the pixel switches are turned off and a compensation voltage is applied to the gate lines.

2. The display device according to claim 1, wherein the compensation voltage has a predetermined value not changing with the level of the pixel voltages.

3. The display device according to claim 1, wherein the suspend period is subsequent to a scan period, where a plurality of scanning pulses are sequentially applied to the gate lines to turn on the pixel switches during the scan period, wherein the compensation voltage is applied to the gate lines at the same timing, so that voltage levels on the gate lines change from a first level to a second level higher than the first level.

4. The display device according to claim 3, wherein the voltage level on each of the gate lines turns back from the second level to the first level before a corresponding pixel switch is switched to ON state in a next scan period.

5. The display device according to claim 4, wherein the voltage levels on the gate lines turns back from the second level to the first level at different timing.

6. The display device according to claim 1, wherein the suspend period is subsequent to a scan period, where a plurality of scanning pulses are sequentially applied to the gate lines to turn on the pixel switches during the scan period, wherein the compensation voltage is applied to the gate lines at the different timing.

7. A display device, comprising:
data lines for providing pixel voltages;
pixel units for displaying images in response to the pixel voltages, the pixel units comprising:
pixel capacitors; and
pixel switches for transmitting the pixel voltages from the data lines to the pixel capacitors;
gate lines for controlling the pixel switches; and
light shield lines disposed along the gate lines;
wherein during a suspend period, the pixel switches are turned off and a compensation voltage is applied to the light shield lines, the compensation voltage has a predetermined value not changing with the level of the pixel voltages.

8. The display device according to claim 7, wherein the suspend period is subsequent to a scan period, where a plurality of scanning pulses are sequentially applied to the light shield lines to turn on the pixel switches during the scan period, wherein the compensation voltage is applied to the light shield lines at the same timing, so that voltage levels on the light shield lines change from a first level to a second level higher than the first level.

9. The display device according to claim 8, wherein the voltage level on each of the light shield lines turns back from the second level to the first level before a corresponding pixel switch is switched to ON state in a next scan period.

10. The display device according to claim 9, wherein the voltage levels on the light shield lines turns back from the second level to the first level at different timing.
